(19) United States
(12) Patent Application Publication
(10) Pub. No.: US 2004/0194034 A1
(43) Pub. Date: Sep. 30, 2004

(54) Computerized scrapbook system

(76) Inventor: Michael Steven Vlamis, Palos Park, IL (US)

Correspondence Address: Michael S. Vlamis, 12924 West Tanglewood Circle, Palos Park, IL, 60464, US

(21) Appl. No.: 10/792,644

(22) Filed: Mar. 3, 2004

Related U.S. Application Data
(60) Provisional application No. 60/458,536, filed on Mar. 31, 2003.

(51) Int. Cl. G06F 17/21

(52) U.S. Cl. 715/530

(57) ABSTRACT

A method and system for users to create and maintain a scrapbook in a computerized system is disclosed and explained. From a single Internet or other communications network site provided according to the invention, a user can create, update, view, search and print a scrapbook. The system enables a user to import images, type notes, maintain a journal, and store memorable information. The user also can readily search and view their stored information. Most importantly, the invention automates the scrapbook process for users and provides users with a format to quickly and cost-effectively create duplicate copies of their scrapbook.

### RELATED APPLICATIONS

This application claims the benefit of priority of U.S. Provisional Patent Application Serial No. 60/458,536, filed Mar. 31, 2003, and entitled “COMPUTERIZED SCRAPBOOK SYSTEM”, the subject matter of which is hereby incorporated by reference herein.

### FIELD OF THE INVENTION

The present invention is relevant and relates to a system and methods for creating and maintaining a scrapbook. The present invention is a completely integrated, computerized system enabling a user to create, maintain, search, view and print a scrapbook that includes birth information, yearly highlights, daily journal entries, developmental information, images, video recordings, and voice recordings.

### DESCRIPTION OF THE RELEVANT PRIOR ART

A scrapbook is a book with blank pages used for the manual mounting and preserving of text, pictures, clippings, or other mementos related to a particular subject.

Prior systems for the general purpose of creating a scrapbook have been developed. After conducting a patent search at the “United States Patent and Trademark Office” web site (www.uspto.gov) for the years 1976 to present, I concluded that until this invention, a computerized scrapbook system was not available to scrapbook users.

Currently, a scrapbook user that wishes to create a scrapbook must manually organize, cut and mount mementos. This is very time consuming for the user.

Additionally, users creating, updating or viewing a scrapbook must be physically located in front of the scrapbook. This method of creating, updating and viewing a scrapbook is not convenient for many users, especially for users working outside of their home.

Scrapbooks produced by manufacturers for scrapbook users generally do not provide the user with an efficient means to record journal entries pertaining to the subject matter of the mementos. A journal entry is very similar to the type of entry a diary user may record. It is an entry that captures a memory or vision in words, not pictures. Today, scrapbook users must create journal entries via hand-written notes or typed notes, which, the user must paste in the scrapbook. This method of creating and organizing journal entries is very inconvenient and inefficient for the user. Therefore, the majority of scrapbook users do not create journal entries.

Scrapbooks produced by manufacturers do not provide users with a convenient format to view live video from within the user's scrapbook. Therefore, users must physically select and locate a viewing device to view videos. This process of eliminating a seamless format to view live video such as a child's first steps, from within a scrapbook, results in a scrapbook that is not complete and convenient for the user.

Scrapbooks produced by manufacturers do not provide users with a convenient format to listen to voice recordings from within the user's scrapbook. Therefore, users must physically select and locate a recording device to listen to voice recordings. This process of eliminating a seamless format to listen to voice recordings such as a child's first word, from within a scrapbook, results in a scrapbook that is not complete and convenient for the user.

Generally, users do not create duplicate copies of a scrapbook and store a duplicate copy of the scrapbook at a location other than their home. To do so would be costly and even more time consuming. If a natural disaster occurred at the location of the scrapbook, the scrapbook may be destroyed and the memories it contains lost forever.

Therefore, what is needed is a scrapbook system that: (1) automatically organizes, mounts, and preserves mementos; (2) can be accessed through an Internet or other communications network via a computing device; (3) enables users to efficiently and quickly create journal entries; (4) provides a convenient format for viewing videos and listening to voice recordings; and (5) enables the user to easily create copies of the scrapbook.

### SUMMARY OF THE INVENTION

It is therefore an object of the present invention to provide a new scrapbook system that; (1) automatically organizes, mounts, and preserves mementos; (2) can be accessed through an Internet or other communications network via a computing device; (3) enables users to efficiently and quickly create journal entries; (4) provides a convenient format for viewing videos and listening to voice recordings; and (5) enables the user to easily create copies of the scrapbook.

Another object of the present invention is to provide an efficient, cost-effective and convenient system for scrapbook users. The invention is a depository of information and process relevant to the scrapbook process. Disclosed is a method for users to create and maintain a scrapbook in a computerized system that is accessed from a single Internet or other communications network through a service provider via a computing device. Enormous time and cost savings can be realized over prior methods by use of this invention, while providing a higher-level of service, convenience, preservation and security to users.

### BRIEF DESCRIPTION OF THE DRAWINGS

FIG. 1 is an illustration of the computing devices and network connections required by the invention.

FIG. 2 is a flow chart of the computerized scrapbook that illustrates the navigation methods and features of the invention.

FIG. 3 is a continuation of FIG. 2 and a flow chart of the birth information section of the invention and illustrates the navigation methods and features of the invention.

FIG. 4 is a continuation of FIG. 2 and a flow chart of the Yearly Highlight information section of the invention and illustrates the navigation methods and features of the invention.

FIG. 5 is a continuation of FIG. 2 and a flow chart of the Journal Entry section of the invention and illustrates the navigation methods and features of the invention.

FIG. 6 is a continuation of FIG. 2 and a flow chart of the Developmental information section of the invention and illustrates the navigation methods and features of the invention.

FIG. 7 is a continuation of FIG. 2 and a flow chart of the Image/Voice Gallery section of the invention and illustrates the navigation methods and features of the invention.

FIG. 8 is a continuation of FIG. 2 and a flow chart of the Printing section of the invention and illustrates the navigation methods and features of the invention.

### DETAILED DESCRIPTION OF THE PREFERRED EMBODIMENTS OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

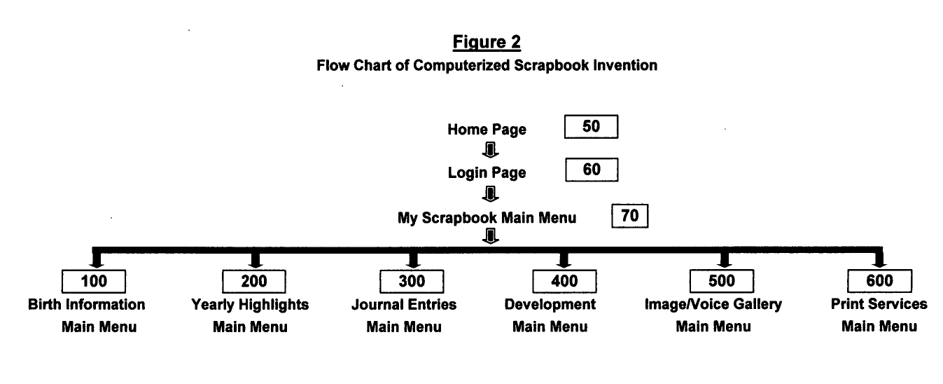

The invention is an integrated, computerized scrapbook comprising of, and as illustrated in FIG. 2, a home page (50), a login in page (60), a main menu (70), birth information (100), yearly highlights (200), journal entries (300), developmental information that includes visual charts (400) and an image/voice gallery (500) that includes video recordings, voice recordings, and images such as, but not limited to, photos, awards, art work, school work, test scores, and medical records.

Unlike prior art, the present invention is a scrapbook system that; (1) automatically organizes, mounts, and preserves mementos; (2) can be accessed through an Internet or other communications network via a computing device; (3) enables users to efficiently and quickly create journal entries; (4) provides a convenient format for viewing videos and listening to voice recordings; and (5) enables the user to easily create copies of the scrapbook.

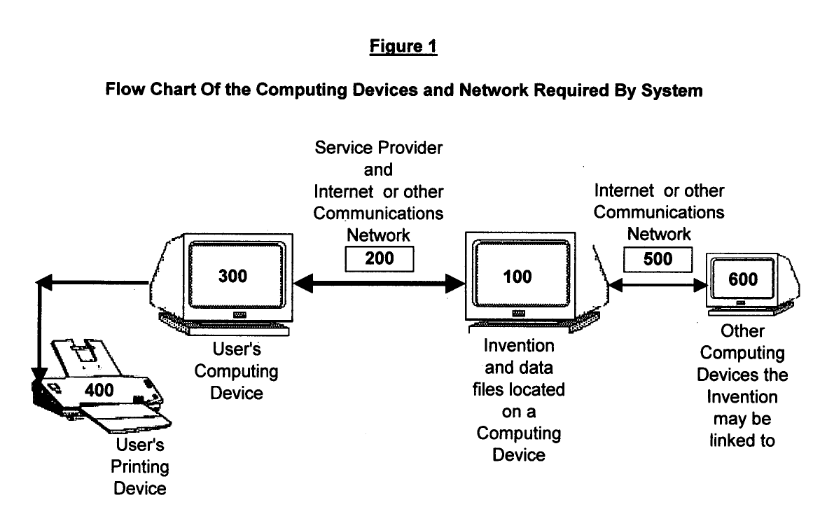

As illustrated in FIG. 1, the invention resides on at least one computer (100) connected to the Internet or other communications network through a service provider (200). A user accesses the computer (100) the invention is located on through a computing device (300) connected to the Internet or other communications network (200) through a service provider. The data that the user enters into the invention is stored in a database in computer 100. The image, video and recording files the user imports into the invention are stored as files in computer 100. The invention provides the user with a format for printing their scrapbook data and images through a browser on their computing device (300), to their printer (400) connected to their computing device (300). Through the invention, users are provided with links to other web sites located on other computers (600) through the Internet or other communications network (500).

The steps of storing, processing, organizing, displaying, searching, and downloading scrapbook mementos are performed automatically by the invention. The invention enables a user to add, view, modify, search and print information relevant to a scrapbook. The computerized scrapbook organizes the user's information and displays the information for the user in an organized format. This method is unlike prior art because this invention automates the scrapbook process.

The invention gathers information from the user regarding birth information such as place, date and time of birth. The invention gathers information from the user regarding yearly highlight information such as favorite foods, names of best friends, favorite activity, and favorite sports. The invention gathers information from the user for journal entries such as special moments and thoughts captured in words. The invention gathers information from the user regarding developmental information such as monthly height and weight. The invention gathers information from the user regarding images such as photos, video recordings and voice recordings.

The invention provides the user with icons to store the gathered information in a database or in a directory on at least one computing device designated by the invention. The invention also provides the user with icons to modify or delete any information stored through the invention on behalf of the user.

The invention processes information to determine the type of action the user wishes the invention to perform as described herein.

The invention organizes information stored by the user by sorting the information by child, placement, date, and category. The invention enables a user to store information on more than one child. The invention enables a user to place information under the birth, yearly highlight, journal entry, developmental, or image/voice gallery. Each entry the user makes is associated with a date that is either entered by the user or is entered by the invention. If the user imports an image, video or voice recording in to the invention, through the invention, the user may select a special category in the image/voice gallery to file the import under. Additionally, a user may place an image, video or voice recording in the birth, yearly highlight, journal entry or image/gallery area of the invention.

The invention provides the user with icons for the viewing of any information stored in the system by the user.

The invention provides the user with icons for the searching of any information stored in the system by the user.

The invention provides the user with icons for the printing of a scrapbook containing all the information the user stored in the system based on criteria specified by the user through the invention.

As illustrated in FIG. 2, at 50, the user views the home page of the web site where the invention resides. At 60, the user logs in to their private computerized scrapbook. At 70, the user is presented with menu choices. The menu choices include access to the user's birth information data (100), yearly highlight data (200), journal entry data (300), developmental data (400), image/voice data (500), and scrapbook printing features (600). Upon a menu selection by the user, a child selection box appears. The user selects a child by clicking on the name of a child. After the user clicks on the name of the child, the user is directed to the area of the invention that the user requested from the scrapbook menu choices above. Only the data specific to that user and child is available to the user.

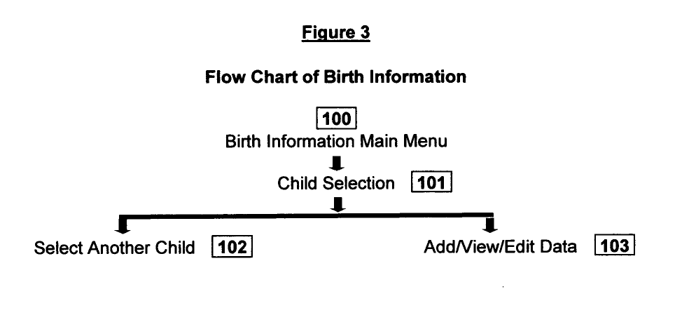

FIG. 3 illustrates the flow of information and features within the Birth Information section of the invention. At 102, the user is allowed access to another child's birth information. At 103, the user is able to add, view, or edit birth information pertaining to the selected child.

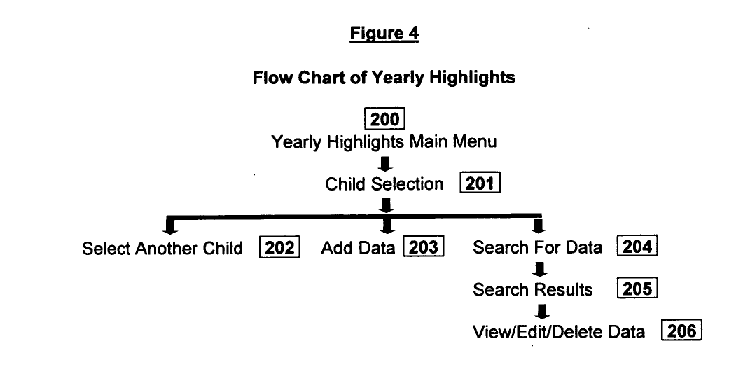

FIG. 4 illustrates the flow of information and features within the Yearly Highlight section of the invention. At 202, the user is allowed access to another child's yearly highlight information. At 203, the user is allowed to add a new record for a new year for the selected child. At 204, the user is allowed to search for a yearly highlight record for the selected child. At 205, all yearly highlight records for the child are displayed. The user selects the yearly highlight record by clicking on the record. At 206, the yearly highlight record is displayed. The users may then view its details, edit the data, or delete the record.

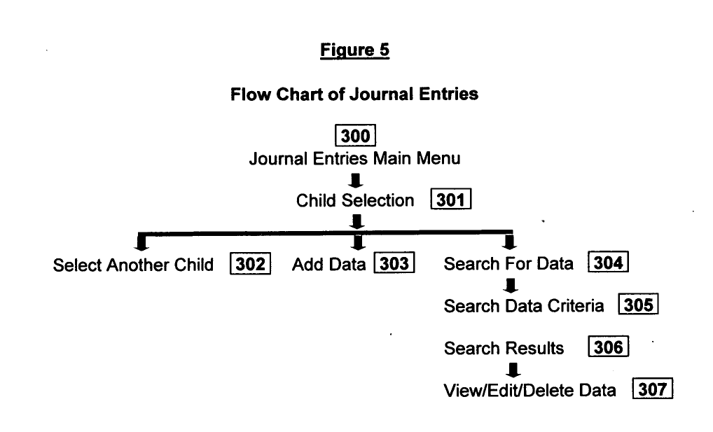

FIG. 5 illustrates the flow of information and features within the Journal Entries section of the invention. At 302, the user is allowed access to another is child's journal entries. At 303, the user is allowed to add a new journal entry for the selected child. At 304, the user is allowed to search for a journal entry record for the selected child. At 305, the user enters the search criteria required to locate a particular journal entry. At 306, all journal entry records for the child, matching the criteria selection of the user, are displayed. The user selects the journal entry record by clicking on the record. At 307, the journal entry record is displayed. The users may then view its details, edit the data, or delete the record.

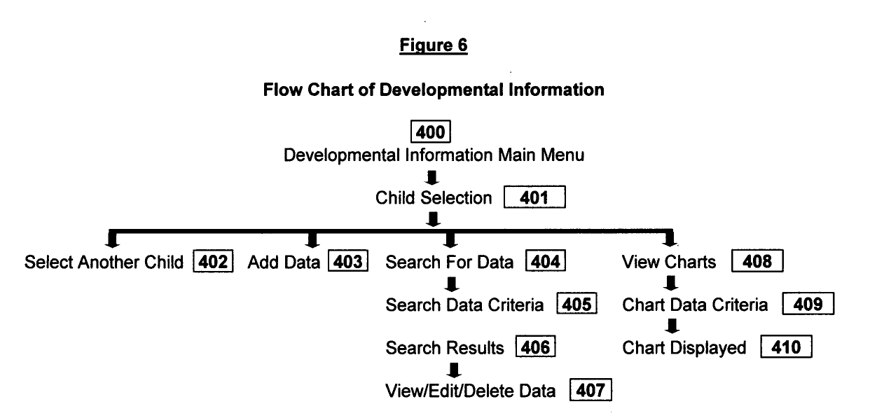

FIG. 6 illustrates the flow of information and features within the Developmental section of the invention. At 402, the user is allowed access to another child's developmental information. At 403, the user is allowed to add a new developmental record for the selected child. At 404, the user is allowed to search for a developmental record for the selected child. At 405, the user enters the search criteria required to locate a particular developmental record. At 406, all developmental records for the child, matching the criteria selection of the user, are displayed. The user selects the developmental record by clicking on the record. At 407, the developmental record is displayed. The users may then view its details, edit the data, or delete the record. At 408, the user may view developmental charts that are compiled from the data entered at 403 and 407. At 409, the user enters the chart display criteria. At 410, the chart, matching the chart data criteria selection of the user, is displayed.

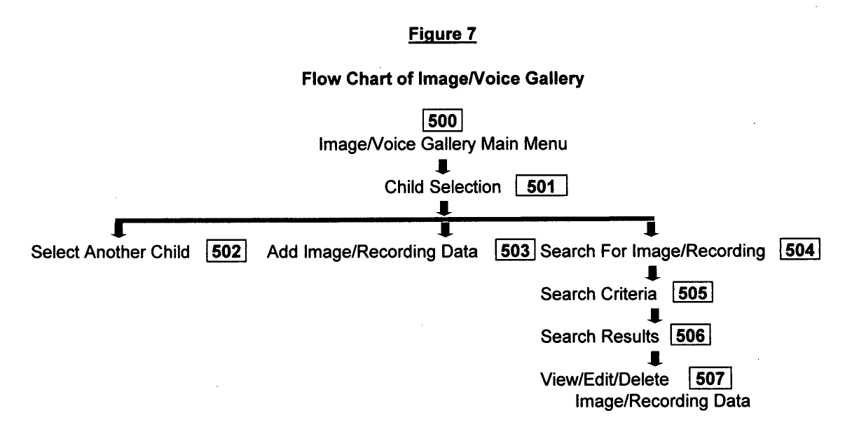

FIG. 7 illustrates the flow of information and features within the Image/Voice Gallery section of the invention. At 502, the user is allowed access to another child's image/voice gallery entries. At 503, the user is allowed to import an image, video recording, or voice recording for the selected child. Additionally, the user can tell the invention to attach the imported file to the birth information record, a yearly highlight record or a journal entry record. The user may assign a name and date to the imported file. At 504, the user is allowed to search for an image/voice gallery entry for the selected child. At 505, the user enters the search criteria required to locate a particular image/voice gallery entry. At 506, all image/voice gallery entry records for the child, matching the criteria selection of the user, are displayed. The user selects the image/voice gallery entry by clicking on the record. At 507, the image/voice gallery entry record is displayed. The users may then view its details, edit the data, or delete the record and it's image, video, or voice file attached. Additionally, the user may tell the invention to attach the image, video or voice file to another birth information record, yearly highlight record or journal entry record.

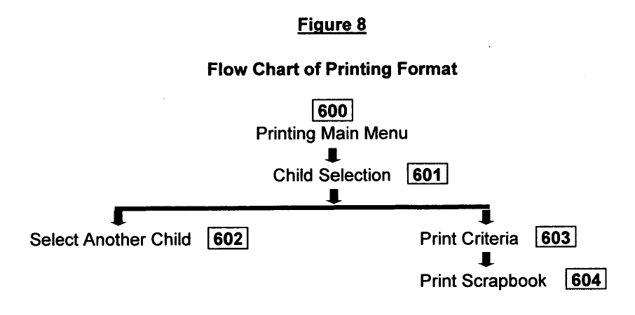

FIG. 8 illustrates the flow of information and features within the Printing section of the invention. At 602, the user is allowed access to another child's print information. At 603, the user is able to enter printing criteria. The user may print the entire scrapbook or print sections of the scrapbook. At 604, the scrapbook will print to the user's printer through the user's browser.

Unlike prior art, an important part of the invention enables the user to access the computerized scrapbook through a computing device connected to the Internet or other communications network. A general purpose computing device in a home, business, non-for-profit organization, government office, school, or residence, such as one running the Windows® 98 or XP or similar program, has software programming installed together with an Internet or other communications network connection as through a service provider. Through the Internet or other communications network such as TV cable, corporate Intranet or Extranet, and the like as may now or hereafter exist, a user logs onto the scrapbook web site to use the computerized scrapbook system. Because of the multi-tasking capabilities of the windows or similar operating system used in the Internet or other communications network site and in the general purpose computer, such as Macintosh, a plurality of “windows” or tasks can be open simultaneously for importing images, video and voice recordings, entering notes and journal entries, and for searching, viewing and printing content.

The present invention permits access through the Internet or other communications network to any of a large plurality of Internet or other communications network sites including any business-to-business, business-to-consumer, or business-to-consumer-to-business sites. This is done by providing links to those sites, usually one pre-selected by the central site but also potentially including ones compiled by the end-user itself, or both.

Unlike prior art, an important part of the invention automatically organizes, mounts, and preserves mementos. The invention enables a user to import images, clippings, or other mementos into the computerized scrapbook. The invention interfaces with the user's computing device by enabling the user to select an image, video, or voice file located on a storage device connected to the user's computing device. The user may then click on an object on the web page to specify the location and category within the invention to place the file. The location may be the birth, yearly highlight, journal or the image/voice gallery. The category may be awards, birthday, report cards and numerous other choices. The user will then enter a date to associate with the file. After the user has selected the file, its location within the scrapbook, and file date, the user clicks on an icon that will force the file to be imported into the computerized scrapbook system under the designated placement location. When the user searches, prints, or views any part of the invention, the files will be sorted by location and date. The users may modify or delete image and voice files at any time.

Unlike prior art, an important part of the invention enables users to efficiently and quickly create journal entries. The user may type a journal entry into the invention and attach a date to each entry. After the user has typed the journal entry and the date associated with the entry, the user clicks on an icon that will store the entry in the computerized scrapbook database. When the user searches, prints, or views any part of the invention, the journal entries will be sorted by date. The users may modify or delete journal entries at any time.

Unlike prior art, an important part of the invention provides a convenient format for viewing videos and listening to voice recordings. The user must access the Internet or other communications network via a browser such as Windows Internet Explorer®. Browser are designed to interact with the user's operating system such as Windows® 2000. Therefore, if a user clicks on a video or voice recording on file within the invention, the browser will look on the hard drive of the user's computing device for software that will play the video or voice recording. If it locates the software, the recording will play immediately. If it does not locate any software that can play the recording, the invention provides the user with links to web sites as illustrated in FIG. 1 at 500 and 600, where the user may download to their computing device, software for the viewing of video recordings or the playing of voice recordings.

Unlike prior art, an important part of the invention enables the user to easily create back-up copies of the computerized scrapbook. As illustrated in FIG. 1 at 400, the user may print the computerized scrapbook at any time from any location connected to the Internet or other communications network.

The invention and its data can be stored in multiple locations through the invention. The invention and the user's data and images, video and recording files are stored on a computing device, illustrated in FIG. 1 at 100, other than the user's and at a location other than the users. Most importantly, the user may download a copy of their scrapbook data to a storage device located on their computing device, illustrated in FIG. 1 at 300. The invention interfaces with the user's computing device by enabling the user to select a location on their computing device where the data files and images, videos, and voice recordings should be stored. The user clicks on a download icon and the application downloads the files through the user's browser to a location specified by the user.

Many variations may be made in the invention as shown and in its manner of use without departing from the principles of the invention as pictured and described herein. Minor variations will not avoid the use of the invention.

I claim:

1. An integrated computerized scrapbook system for use on and in connection with a computing device connected to the Internet or other communications network, the system comprising,
a method for gathering information regarding at least one of a birth information, yearly highlight information, journal entries, developmental information, images, video or voice recordings; and
a method for storing information regarding birth information, yearly highlight information, journal entries, developmental information, images, video or voice recordings; and
a method for processing information regarding birth information, yearly highlight information, journal entries, developmental information, images, video or voice recordings; and
a method for organizing information regarding birth information, yearly highlight information, journal entries, developmental information, images, video or voice recordings; and
a method for displaying information regarding birth information, yearly highlight information, journal entries, developmental information, images, video or voice recordings; and
a method for viewing and listening to video or voice recordings; and
a method for searching information regarding birth information, yearly highlight information, journal entries, developmental information, images, video or voice recordings; and
a method for downloading information regarding birth information, yearly highlight information, journal entries, developmental information, images, video or voice recordings; and
a method for printing information regarding birth information, yearly highlight information, journal entries, developmental information, images, video or voice recordings.

2. The computerized scrapbook system of claim 1 wherein the steps of storing, processing, organizing, displaying, searching, and downloading scrapbook mementos are performed automatically.
